(19) United States
(12) Patent Application Publication
(10) Pub. No.: US 2008/0199619 A1
(43) Pub. Date: Aug. 21, 2008

(54) Method Of Manufacturing For Aromatic Polyamide Composite Membrane

(75) Inventors: Jae Hee Ryu, Gyeonggi-do (KR); Sung Hak Choi, Gyeonggi-do (KR); Kwang Jin Lee, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: Kolon Industries, Inc., Kwacheon-si (KR)

(21) Appl. No.: 12/063,070

(22) PCT Filed: Aug. 8, 2006
(86) PCT No.: PCT/KR2006/003101

§ 371 Date: Feb. 6, 2008

(30) Foreign Application Priority Data
Aug. 8, 2005 (KR) 10-2005-0072309
Dec. 12, 2005 (KR) 10-2005-0121439

(51) Int. Cl. B05D 3/10

(52) U.S. Cl. 427/340

(57) ABSTRACT

The present invention provides a method of manufacturing an aromatic polyamide composite membrane comprising: coating an aqueous solution containing polyfunctional aromatic amine to a porous polymer substrate; and reacting the coated substrate with an organic solution containing polyfunctional aromatic acyl halide to lead to interfacial condensation polymerization between the polyfunctional aromatic amine and the polyfunctional aromatic acyl halide so that the reaction product resulting from the interfacial condensation polymerization is coated on the surface of the substrate, characterized in that either of the aqueous solution containing polyfunctional aromatic amine or the organic solution containing polyfunctional aromatic acyl halide has dendritic polymer as one of polyfunctional compounds added thereto. The resulting aromatic polyamide composite membrane which includes dendrimer as polyfunctional compound, exhibits high salt rejection rate and water flux.

### TECHNICAL FIELD

The present invention relates to a method of manufacturing aromatic polyamide composite membrane, and more particularly, to a method of manufacturing novel aromatic polyamide composite membrane which contains dendritic polymer as polyfunctional compound, and has high salt rejection rate and water flux.

It is well known that aromatic polyamide composite membrane (or occasionally so-called reverse-osmosis membrane) has excellent salt rejection rate and water flux, and is applicable in a wide range of applications including water purifier for home appliances, industrial ultra-pure water production, waste water treatment, seawater desalination or the like. In order to improve performance of the aromatic polyamide composite membrane, extensive studies and investigation are now in progress.

### BACKGROUND ART

As disclosed in prior arts, for example, U.S. Pat. No. 4,277,344, aromatic polyamide composite membrane is manufactured by coating surface of a porous polymer substrate by interfacial condensation polymerization between polyfunctional aromatic amine and polyfunctional aromatic acyl halide.

To improve the performance of the aromatic polyamide composite membrane, it is required to have a high flow rate at a reasonable transmembrane pressure and to have a high rejection characteristic for the dissolved or dispersed material being separated from the solvent. In order to achieve these purposes, there have been recent attempts to apply a variety of additives to conventional processes that particularly use m-phenylenediamine or triaminobenzene as the polyfunctional aromatic amine and trimesoyl chloride or isophthaloyl dichloride as the polyfunctional aromatic acyl halide.

U.S. Pat. No. 4,872,984 suggested addition of tertiary amine as well as strong acid or tetraalkyl ammonium hydroxide in fabrication of a composite membrane, while U.S. Pat. No. 6,723,241 disclosed that phosphorus compound is added to improve membrane performance. However, such additives have a problem in that the additive remains on a composite membrane through physical bonding, thus, causing dissolution during use of a reverse osmosis membrane.

Polyamidoamine (hereinafter abbreviated to “PAMAM”) which is representative of starburst dendrimer, has a structural characteristic of having a number of reactive groups bonded at the terminal and optionally substituted the terminal groups with others, thus, is useful for life science fields such as biological sensors and also adaptable for chemical sensors, liquid or gas adsorbent film, membrane, low dielectric material or lithography process or the like.

Korean Patent No. 10-0356282 proposed a method for fabricating surface modified membrane characterized in that the surface of a polymer film or a polymer membrane is coated with dendritic polymer or dendritic polymer substituted by active material after modifying the surface of the polymer film or the polymer membrane by means of plasma or UV radiation to derive covalent bond at membrane boundary. But, this method has a disadvantage in that it is difficult to express inherent properties of the dendritic polymer, since the bond between the dendritic polymer and the membrane is more like to the physical bond and causes easy desorption of the dendritic polymer.

### DISCLOSURE OF THE INVENTION

### (Technical Problem)

Therefore, in order to overcome the above conventional problem in relation to the dendritic polymer being easily released from the composite membrane, the present invention provides novel aromatic polyamide composite membrane with enhanced salt rejection rate and water flux, as well as rigid bonding between dendritic polymer and a membrane by adding the dendritic polymer as one of polyfunctional compounds in a chemical reaction process for producing the aromatic polyamide composite membrane.

### (Technical Means to Solve the Problem)

Hereinafter, the present invention will be described in detail.

The present invention provides a method of manufacturing an aromatic polyamide composite membrane comprising: coating an aqueous solution containing polyfunctional aromatic amine to a porous polymer substrate; and reacting the coated substrate with an organic solution containing polyfunctional aromatic acyl halide to lead to interfacial condensation polymerization between the polyfunctional aromatic amine and the polyfunctional aromatic acyl halide so that the reaction product resulting from the interfacial condensation polymerization is coated on the surface of the substrate, characterized in that either of the aqueous solution containing polyfunctional aromatic amine or the organic solution containing polyfunctional aromatic acyl halide has dendritic polymer as one of polyfunctional compounds added thereto.

The dendritic polymer serving as a polyfunctional compound comprises dendritic polymer having amine substituted terminal or dendritic polymer having acyl halide substituted terminal. In particular, the dendritic polymer includes PAMAM dendrimer having amine terminal and/or PAMAM dendrimer having the terminal substituted by acyl halide.

Also, as the polyfunctional compound, the dendritic polymer may include Starburst dendrimer having more than a half generation of exterior surface.

The dendritic polymer may have heteroatom and/or functional group in dentritic structure.

The above heteroatom comprises nitrogen or oxygen and the like, while the functional group includes amide group, acetate group or ether group.

Also, alternative example of the dendritic polymer may be dendritic polymer that has a core compound substituted by any one selected from N-alkylamine, N-arylamine, alkyldiamine or aryldiamine, etc. instead of typically known ammonia.

More preferably, the aqueous solution containing polyfunctional aromatic amine has the dendritic polymer having the amine substituted terminal added thereto. On the other hand, the organic solution containing polyfunctional aromatic acyl halide preferably has the dendritic polymer having the acyl halide substituted terminal added thereto.

Polyfunctional aromatic amine used in the present invention includes m-phenylenediamine, piperazine or triaminobenzene, etc., while polyfunctional aromatic acyl halide used in the present invention may be trimesoyl chloride or isophthaloyl dichloride, etc.

In addition, the above polyfunctional compound, that is, the dendritic polymer may have at least one selected from a group consisting of boron compound, silicon compound, phosphorus compound and sulfur compound which is introduced in interior dendritic structure(the branches) of the dendrimer.

Moreover, in a process for synthesis of dendrimer, partially introduced is boron compound, silicon compound, phosphorus compound or sulfur compound in a known dendrimer by reaction of the dendrimer with boron compound, silicon compound, phosphorus compound or sulfur compound, leading to synthesis of novel dendrimer and use thereof.

When the dendrimer having another compound introduced therein is used, a reverse-osmosis composite membrane containing the dendrimer is produced by entirely or partially replacing the terminal of the dendrimer with amine or acyl halide.

Silicon compound introduced in dendrimer chain includes but is not limited to, any one selected from a group consisting of chlorosilane, alkylsilane, arylsilane, alkoxysilane and aminesilane.

Phosphorus compound introduced in dendrimer includes but is not limited to, any one selected from a group consisting of alkyl phosphine, aryl phosphine, alkyl phosphate, aryl phosphate, alkoxy phosphine, alkyl phosphite, aryl phosphite, alkoxy phosphate and phosphazene.

Sulfur compound introduced in dendrimer chain includes but is not limited to, any one selected from a group consisting of sulfide compound, sulfonate compound and sulfoxide compound.

The composite membrane fabricated by adding the dendritic polymer, in which the boron compound, silicon compound, phosphorus compound or sulfur compound is introduced, into the dendrimer structure, exhibits enhanced salt rejection rate and high flow rate, compared with conventional aromatic polyamide composite membrane, because of structural characteristic of dendrimer, chemical properties of the boron compound, silicon compound, phosphorus compound or sulfur compound introduced therein, and structural characteristic of the resulting polymer.

Furthermore, the above dendritic polymer may be alternative dendritic polymer having alternative amine, boron compound, silicon compound, phosphorus compound or sulfur compound as the central core, in place of ammonia which has been typically used.

Meanwhile, the porous polymer substrate is a polymer membrane which is obtained with pore size in nano-filtration or ultra-filtration level, and may be prepared by using any one or two selected from a polymer group consisting of polysulfone, polyethersulfone, polyamide, polyethylene, polypropylene, polyacetate, polyacrylonitrile and polyvinylidene fluoride.

As to application of the aqueous solution containing the polyfunctional amine to the porous polymer substrate, commonly known methods such as dipping or spraying are desirably used. After applying, the aqueous solution excessively applied to the surface of the porous polymer substrate can be removed by using air-knife, roller or sponge and other known means.

Content of the polyfunctional aromatic amine in the aqueous solution ranges from 0.1 to 25% by weight, and more preferably, 0.2 to 10% by weight.

If the content is below 0.1% by weight, the aqueous solution containing the polyfunctional aromatic amine cannot be uniformly wettable on the porous polymer substrate. Otherwise, when the content is above 25% by weight, thickness of the resulting composite membrane increases and causes flow rate to be reduced.

Also, the aqueous solution containing the polyfunctional aromatic amine has preferably pH 7 to 12.

Furthermore, in order to enable the porous polymer substrate to be in contact with the organic solution containing the polyfunctional aromatic acyl halide after applying the aqueous solution containing the polyfunctional amine to the porous polymer substrate, it is possible to use a method for dipping the porous polymer substrate in the organic solution or a method for spraying the organic solution over the porous polymer substrate.

Content of the polyfunctional aromatic acyl halide in the organic solution ranges from 0.01 to 10% by weight, and more preferably, 0.02 to 5% by weight.

If the content is below 0.01% by weight, the interfacial condensation polymerization is not completely carried out. On the other hand, when the content exceeds 10% by weight, thickness of the resulting composite membrane increases and causes flow rate to be reduced.

Content of the dendritic polymer included in either of the aqueous solution containing the polyfunctional aromatic amine or the organic solution containing the polyfunctional aromatic acyl halide ranges from 0.001 to 5% by weight, and more preferably, 0.005 to 0.5% by weight relative to total weight of each of the aqueous solution and the organic solution.

In addition, organic solvent used in the present invention includes but is not limited to, freons, isoparaffin mixtures, or hydrocarbons of which the number of carbon atoms ranges from 5 to 20. The interfacial condensation polymerization takes 5 seconds to 10 minutes and, preferably, 10 seconds to 2 minutes. If the reaction time is 15 less than 5 seconds, the polymerization does not regularly proceed over the surface of the polymer substrate causing the salt rejection rate to be decreased. Conversely, when the reaction time exceeds 10 minutes, the thickness of the composite membrane increases, thus causing reduction of water flux.

The reverse-osmosis composite membrane prepared as described above is then washed with ultra-pure water or aqueous solution containing low concentration of carbonate, followed by drying the washed membrane. Temperature of the washing water is controlled in the range of 20 to 50° C.

As illustrated in the foregoing description, the reverse-osmosis composite membrane prepared by the present invention can overcome the disadvantage of additive dissolution since the dendritic polymer used as the additive is chemically bonded to the membrane in manufacturing the aromatic polyamide composite membrane, and has excellent salt rejection rate and high flow rate dus to the original characteristic of the dendritic polymer.

### (Advantageous Effects)

As described in detail above, the present invention provides aromatic polyamide composite membrane containing dendritic polymer as an additive which is chemically bonded to the membrane during production of the membrane, thereby solving the dissolution problem of the additive.

Also, because of the original characteristic of dendritic polymer, the aromatic polyamide composite membrane has significantly improved salt rejection rate and water flux.

### BEST MODE FOR CARRYING OUT THE INVENTION

Features of the present invention described above and other advantages will be more clearly understood by the following non-limiting examples and comparative example. However, it will be obvious to those skilled in the art that the present invention is not restricted to the specific matters stated in the examples below.

### EXAMPLE 1

A porous polysulfone substrate to have thickness of 150 μm was immersed in an aqueous solution of 2% by weight of m-phenylenediamine and 0.05% by weight of polyamidoamine dendrimer (generation 1) for 1 minute, and excess of the aqueous solution was removed from the substrate by a rubber roller. Such treated porous polymer substrate was again immersed in an organic solution of 0.2% by weight trimesoyl chloride for about 1 minute. After completing the reaction, the coated polysulfone substrate was dried for 1 minute under air and washed with an aqueous solution of low concentration of carbonate at room temperature for 30 minutes, resulting in the aromatic polyamide composite membrane.

### EXAMPLE 2

A porous polysulfone substrate to have thickness of 150 μm was immersed in an aqueous solution of 2% by weight of m-phenylenediamine for 1 minute, and excess of the aqueous solution was removed from the substrate by a rubber roller.

Such treated porous polymer substrate was again immersed in an organic solution of 0.2% by weight trimesoyl chloride and 0.05% by weight of polyamidoamine dendrimer (generation 1) having acyl halide substituted terminal for 1 minute. Upon completion of the reaction, the coated polysulfone substrate was dried for 1 minute under air and washed with an aqueous solution of low concentration of carbonate at room temperature for 30 minutes, resulting in the aromatic polyamide composite membrane.

### EXAMPLES 3 TO 6

The aromatic polyamide composite membrane was prepared by the same procedure as in Example 1 except that species of polyamidoamine dendrimers added to the aqueous solution of m-phenylenediamine solution were altered as shown in the following Table 1.

TABLE 1

| Section | Species of dendrimer |
|---|---|
| Example 3 | Polyamidoamine dendrimer (Generation 0.5) |
| Example 4 | Polyamidoamine dendrimer (Generation 1.5) |
| Example 5 | Polyamidoamine dendrimer (Generation 2) |
| Example 6 | Polyamidoamine dendrimer (Generation 4) |

### EXAMPLES 7 TO 10

The aromatic polyamide composite membrane was prepared by the same procedure as in Example 2 except that species of polyamidoamine dendrimers having acyl halide substituted terminal added to the organic solution of trimesoyl chloride were altered as shown in the following Table 2.

TABLE 2

| Section | Species of dendrimer |
|---|---|
| Example 7 | Polyamidoamine dendrimer (Generation 0.5) |
| Example 8 | Polyamidoamine dendrimer (Generation 1.5) |
| Example 9 | Polyamidoamine dendrimer (Generation 2) |
| Example 10 | Polyamidoamine dendrimer (Generation 4) |

### EXAMPLE 11

A porous polysulfone substrate to have thickness of 150 μm was immersed in an aqueous solution of 2% by weight of m-phenylenediamine and 0.1% by weight of starburst dendrimer (generation 1) which has phosphorus compound as an interior dendritic sturcture for 1 minute, and excess of the aqueous solution was removed from the substrate by a rubber roller. Such treated porous polysulfone substrate was again immersed in an organic solution of 0.2% by weight trimesoyl chloride for about 1 minute. After completing the reaction, the coated polysulfone substrate was dried for 1 minute under air and washed with an aqueous solution of low concentration of carbonate at room temperature for 30 minutes, resulting in the aromatic polyamide composite membrane.

### EXAMPLE 12

A porous polysulfone substrate to have thickness of 150 μm was immersed in an aqueous solution of 2% by weight of m-phenylenediamine for 1 minute, and excess of the aqueous solution was removed from the substrate by a rubber roller.

Such treated porous polysulfone substrate was again immersed in an organic solution of 0.2% by weight trimesoyl chloride and 0.05% by weight of polyamidoamine dendrimer (generation 1) which has phosphorus compound as an interior dendritic structure and acyl halide as an exterior surface for 1 minute. Upon completion of the reaction, the product was dried for 1 minute under air and washed with an aqueous solution of low concentration of carbonate at room temperature for 30 minutes, resulting in the aromatic polyamide composite membrane.

### EXAMPLES 13 TO 17

The aromatic polyamide composite membrane was prepared by the same procedure as in Example 11 except that species of polyamidoamine dendrimers added to the aqueous solution of m-phenylenediamine solution were altered as shown in the following Table 3.

TABLE 3

| Section | Species of dendrimer |
|---|---|
| Example 13 | Polyamidoamine dendrimer (Generation 0.5) |
| Example 14 | Polyamidoamine dendrimer (Generation 1.5) |
| Example 15 | Polyamidoamine dendrimer (Generation 2) |
| Example 16 | Polyamidoamine dendrimer (Generation 4) |
| Example 17 | Polyamidoamine dendrimer (Generation 5) |

### EXAMPLES 18 TO 22

The aromatic polyamide composite membrane was prepared by the same procedure as in Example 12 except that species of polyamidoamine dendrimers having acyl halide substituted terminal added to the organic solution of trimesoyl chloride were altered as shown in the following Table 4.

TABLE 4

| Section | Species of dendrimer |
|---|---|
| Example 18 | Polyamidoamine dendrimer (Generation 0.5) |
| Example 19 | Polyamidoamine dendrimer (Generation 1.5) |
| Example 20 | Polyamidoamine dendrimer (Generation 2) |
| Example 21 | Polyamidoamine dendrimer (Generation 4) |
| Example 22 | Polyamidoamine dendrimer (Generation 5) |

### EXAMPLE 23

A porous polysulfone substrate to have thickness of 150 μm was immersed in an aqueous solution of 2% by weight of m-phenylenediamine and 0.1% by weight of polyamidoamine dendrimer (generation 1) which has silicon compound as an interior dendritic structure for 1 minute, and excess of the aqueous solution was removed from the substrate by a rubber roller. Such treated porous polymer substrate was again immersed in an organic solution of 0.2% by weight trimesoyl chloride for about 1 minute. After completing the reaction, the coated polysulfone substrate was dried for 1 minute under air and washed with an aqueous solution of low concentration of carbonate at room temperature for 30 minutes, resulting in the aromatic polyamide composite membrane.

### EXAMPLE 24

A porous polysulfone substrate to have thickness of 150 μm was immersed in an aqueous solution of 2% by weight of m-phenylenediamine and 0.1% by weight of polyamidoamine dendrimer (generation 1) which has boron compound as an interior dendritic structure for 1 minute, and excess of the aqueous solution was removed from the substrate by a rubber roller. Such treated porous polysufone substrate was again immersed in an organic solution of 0.2% by weight trimesoyl chloride for about 1 minute. After completing the reaction, the coated polysulfone substrate was dried for 1 minute under air and washed with an aqueous solution of low concentration of carbonate at room temperature for 30 minutes, resulting in the aromatic polyamide composite membrane.

### Comparative Example 1

A porous polysulfone substrate to have thickness of 150 μm was immersed in an aqueous solution of 2% by weight of m-phenylenediamine for 1 minute, and excess of the aqueous solution was removed from the substrate by a rubber roller. Such treated porous polysufone substrate was again immersed in an organic solution of 0.2% by weight trimesoyl chloride for 1 minute.

Upon completion of the reaction, the coated polysulfone substrate was dried for 1 minute under air and washed with an aqueous solution of low concentration of carbonate at room temperature for 30 minutes, resulting in the aromatic polyamide composite membrane.

The water flux and the salt rejection rate of the prepared aromatic polyamide composite membrane by the examples 1˜24 and the comparative example 1 were determined by using 2,000 ppm of NaCl aqueous solution at room temperature under a constant pressure of 225 psig and the test results are shown in Table 5.

TABLE 5

| | Water flux | Salt rejection |
|---|---|---|
| section | (gallon/ft²/day) | rate (%) |
| Example 1 | 17.9 | 97.7 |
| Example 2 | 18.4 | 98.0 |
| Example 3 | 18.5 | 98.5 |
| Example 4 | 20.1 | 98.9 |
| Example 5 | 19.8 | 99.1 |
| Example 6 | 17.6 | 98.6 |
| Example 7 | 18.8 | 98.2 |
| Example 8 | 19.5 | 98.5 |
| Example 9 | 19.7 | 98.3 |
| Example 10 | 18.3 | 98.0 |
| Example 11 | 18.1 | 97.6 |
| Example 12 | 18.0 | 97.9 |
| Example 13 | 17.9 | 98.1 |
| Example 14 | 18.6 | 98.5 |
| Example 15 | 18.9 | 98.6 |
| Example 16 | 17.4 | 97.1 |
| Example 17 | 17.1 | 97.3 |
| Example 18 | 17.8 | 98.3 |
| Example 19 | 18.4 | 98.6 |
| Example 20 | 18.8 | 98.5 |
| Example 21 | 16.9 | 97.8 |
| Example 22 | 16.8 | 97.5 |
| Example 23 | 19.1 | 98.7 |
| Example 24 | 17.9 | 99.1 |
| Comparative | 16.2 | 97.5 |
| example 1 | | |

### INDUSTRIAL APPLICABILITY

As described above, the present invention accomplishes production of aromatic polyamide composite membrane with superior salt rejection rate and water flux preferably used in various apparatuses including such as ultra-pure water production facilities, waste water treatment apparatus, seawater desalination facility, etc.

1. A method of manufacturing an aromatic polyamide composite membrane comprising: coating an aqueous solution containing polyfunctional aromatic amine to a porous polymer substrate; and reacting the coated substrate with an organic solution containing polyfunctional aromatic acyl halide to lead to interfacial condensation polymerization between the polyfunctional aromatic amine and the polyfunctional aromatic acyl halide so that the reaction product resulting from the interfacial condensation polymerization is coated on the surface of the substrate, characterized in that either of the aqueous solution containing polyfunctional aromatic amine or the organic solution containing polyfunctional aromatic acyl halide has dendritic polymer as one of polyfunctional compounds added thereto.

2. The method according to claim 1, wherein the dendritic polymer as the polyfunctional compound is dendritic polymer having amine substituted terminal or dendritic polymer having acyl halide substituted terminal.

3. The method according to claim 1, wherein the aqueous solution containing the polyfunctional aromatic amine comprises dendritic polymer having amine substituted terminal added thereto.

4. The method according to claim 1, wherein the organic solution containing the polyfunctional aromatic acyl halide comprises dendritic polymer having acyl halide substituted terminal added thereto.

5. The method according to claim 1, wherein the dentritic polymer as the polyfunctional compound is Starburst dendrimer having at least 0.5 generation of exterior surface.

6. The method according to claim 1, wherein the dendritic polymer comprises heteroatoms in dentritic structure.

7. The method according to claim 6, wherein the heteroatom comprises nitrogens or oxygens.

8. The method according to claim 1, wherein the dendritic polymer comprises at least one selected from amide group, acetate group and ether group in dentritic structure.

9. The method according to claim 1, wherein the dendritic polymer comprises a core compound selected from a group consisting of ammonia, N-alkylamine, N-arylamine, alkyldiamine and aryldiamine.

10. The method according to claim 1, wherein the dendritic polymer as the polyfunctional compound compries at least one compound selected from boron compound, silicon compound, phosphorus compound and sulfur compound introduced in dendritic polymeric chains.

11. The method according to claim 10, wherein the silicon compound introduced in the dendritic polymer chain is at least one selected from a group consisting of chlorosilane, alkylsilane, arylsilane, alkoxysilane and aminesilane.

12. The method according to claim 10, wherein the phosphorus compound introduced in the dendritic polymer chain is at least one selected from a group consisting of alkyl phosphine, aryl phosphine, alkyl phosphate, aryl phosphate, alkoxy phosphine, alkyl phosphite, aryl phosphite, alkoxy phosphite and phosphazene.

13. The method according to claim 10, wherein the sulfur compound introduced in the dendritic polymer chain is at least one selected from a group consisting of sulfide compound, sulfonate compound and sulfoxide compound.

14. The method according to claim 1, wherein amount of the dendritic polymer added to either of the aqueous solution containing the polyfunctional aromatic amine or the organic solution containing the polyfunctional acyl halide ranges from 0.001 to 5% by weight relative to total weight of each of the aqueous solution and the organic solution.
